(19) United States
(12) Patent Application Publication
(10) Pub. No.: US 2014/0341070 A1
(43) Pub. Date: Nov. 20, 2014

(54) WIRELESS NETWORK SETTING METHOD, COMMUNICATION SYSTEM AND REMOTE DEVICE

(71) Applicant: Sercomm Corporation, Taipei (TW)

(72) Inventors: Yu-Li Shen, Taipei (TW); Chih-Sheng Kuo, Keelung (TW); Shao-Hai Zhao, Jiangsu (CN)

(73) Assignee: Sercomm Corporation, Taipei (TW)

(21) Appl. No.: 14/188,766

(22) Filed: Feb. 25, 2014

(30) Foreign Application Priority Data
May 14, 2013 (CN) 201310178341.3

(51) Int. Cl. H04W 72/04; H04W 76/02

(52) U.S. Cl. CPC H04W 72/042; H04W 76/02
USPC 370/254

(57) ABSTRACT

A wireless network setting method applied to a wireless network communication system is provided. The wireless network communication system includes a wireless network base station, a remote device and a universal repeater. The setting method includes following steps. The wireless network base station provides a wireless network. The wireless network base station signally connects to the remote device and transmits a setting parameter corresponding to the wireless network. The remote device receives and stores the setting parameter corresponding to the wireless network. The universal repeater signally connects to the remote device. The universal repeater and the remote device activate a transmission procedure of network setting according to a trigger signal. In the transmission procedure of network setting, the remote device transmits the setting parameter corresponding to the wireless network to the universal repeater.

This application claims the benefit of People's Republic of China application Serial No. 201310178341.3, filed on May 14, 2013, the subject matter of which is incorporated herein by reference.

### BACKGROUND

1. Technical Field

The invention relates in general to a wireless network setting method, a communication system and a remote device, and more particularly, to a wireless network setting method, a communication system and a remote device that store a setting parameter corresponding to a wireless network.

2. Related Art

A wireless local area network (WLAN) involves no cables as a common local area network (LAN, e.g., Ethernet) does, and thus offers great convenience. Therefore, the WLAN has become more and more popular in the recent years.

Apart from a wireless network base station and a remote device, the WLAN may further include a universal repeater capable of extending wireless network signals. In order to correctly configure a universal repeater, a user often needs to not only manually carry out a setting procedure via an interface but also repeatedly perform such setting procedure for every universal repeater and remote device. The above method is time and effort consuming as well as prone to errors during the setting procedure. Therefore, there is a need for a solution for setting a universal repeater.

### SUMMARY

According to an aspect of the present invention, a wireless network setting method applied to a wireless network base station, a remote device and a universal repeater is provided. The setting method includes steps of: the wireless network base station providing a wireless network; the wireless network base station establishing a signal connection to the remote device and transmitting a setting parameter corresponding to the wireless network; the remote device receiving and storing the setting parameter corresponding to the wireless network; the universal repeater establishing a signal connection to the remote device; and the universal repeater and the remote device activating a transmission procedure of network setting according to a trigger signal. In the transmission procedure of network setting, the setting parameter corresponding to the wireless network is transmitted to the universal repeater.

According to another aspect of the present invention, a wireless network communication system is provided. The wireless network communication system includes: a wireless network base station, for providing a wireless network; a remote device, signally connected to the wireless network base station, for receiving and storing a setting parameter corresponding to the wireless network, wherein the setting parameter is transmitted from the wireless network base station; and a universal repeater, signally connected to the remote device. The universal repeater and the remote device activate a transmission procedure of network setting according to a trigger signal, and the remote device transmits the setting parameter corresponding to the wireless network to the universal repeater in the transmission procedure of network setting.

According to yet another aspect of the present invention, a remote device is provided. The remote device is signally connected to a wireless network base station that provides a wireless network. The remote device includes: a transceiver module, signally connected to the wireless network base station, for receiving a setting parameter corresponding to the wireless network; a storage module, electrically connected to the transceiver module, for storing the setting parameter corresponding to the wireless network; and a trigger module, electrically connected to the transceiver module, for generating a trigger signal and accordingly activating a transmission procedure of network setting. The transceiver module is signally connected to a universal repeater in the transmission procedure of network setting and transmits the setting parameter corresponding to the wireless network to the universal repeater.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a wireless network communication system according to an embodiment of the present invention;

FIGS. 2A, 2B and 2C are schematic diagrams illustrating relationships of three stages in a setting process of a wireless network communication system according to an embodiment of the present invention;

FIG. 3 is a schematic diagram of applying the present invention to a wireless network communication system;

FIG. 4 is a schematic diagram of applying the present invention to another wireless network communication system;

FIG. 5 is a schematic diagram of applying the present invention to yet another wireless network communication system; and

FIG. 6 is a flowchart of a wireless network setting method according to an embodiment of the present invention.

### DETAILED DESCRIPTION

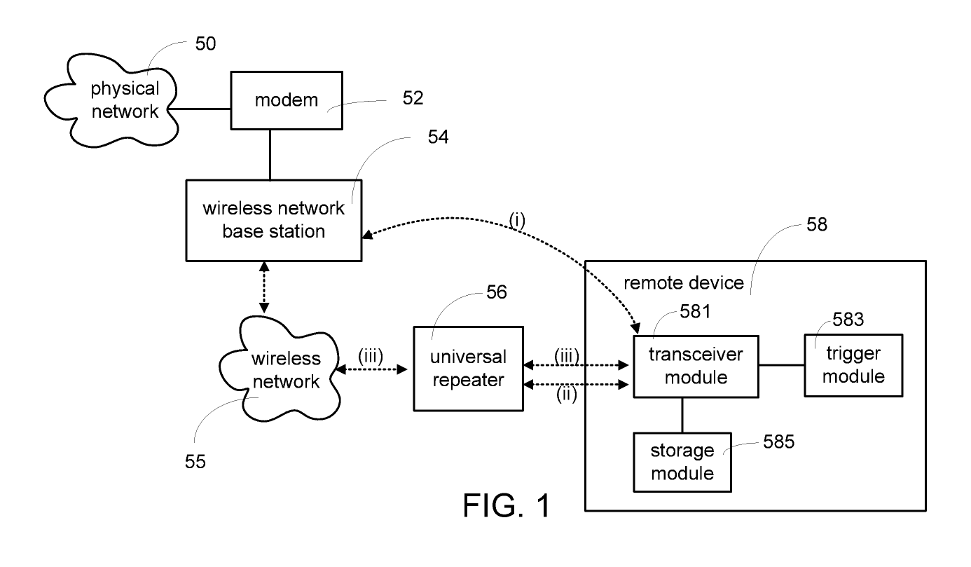

FIG. 1 shows a block diagram of a wireless network communication system according to an embodiment of the present invention. The wireless network communication system includes a wireless network base station 54, a universal repeater 56, and a remote device 58. The wireless network base station 54 provides a wireless network 55, and connects to a physical network 50, e.g. via a modem 52.

Referring to FIG. 1, the remote device 58 includes a transceiver module 581, a trigger module 583, and a storage module 585. The transceiver module 581 is electrically connected to the trigger module 583 and the storage module 585.

The transceiver module 581 receives a setting parameter, which is corresponding to the wireless network 55 and is transmitted from the wireless network base station 54. The storage module 585 stores the setting parameter corresponding to the wireless network 55. The trigger module 583 generates a trigger signal, according to which the remote device 58 activates a transmission procedure of network setting. In the transmission procedure of network setting, the transceiver module 581 is signally connected to the universal repeater 56, and transmits the setting parameter corresponding to the wireless network 55 to the universal repeater 56.

The universal repeater 56 is signally connected to the remote device 58. The transmission procedure of network setting is activated by the universal repeater 56 and the remote device 58 according to the trigger signal. Further, the universal repeater 56 receives the setting parameter corresponding to the wireless network 55 via the transmission procedure of network setting, and then signally connects to the wireless network 55 according to the setting parameter in a normal operation procedure.

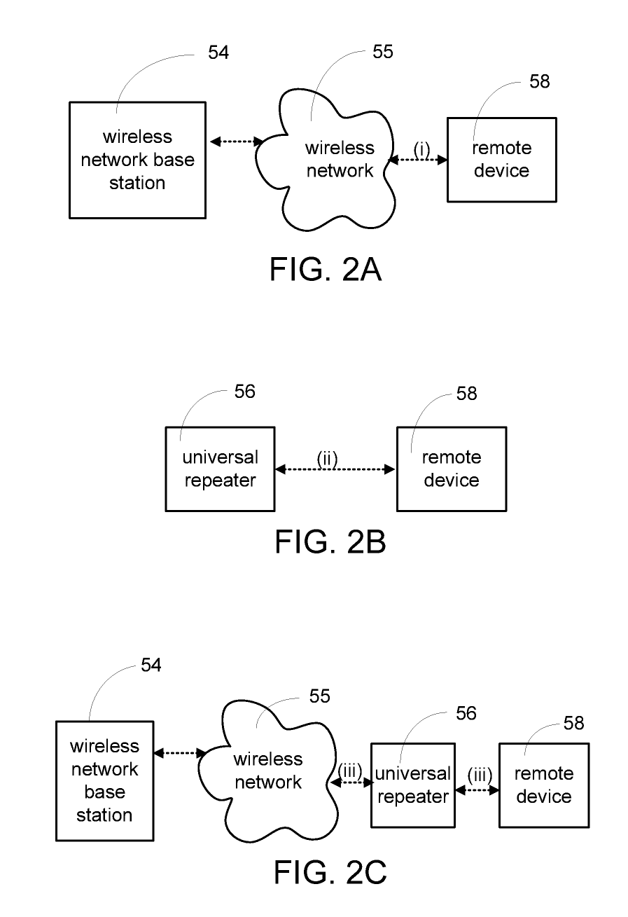

For example, signal connections and interactions among the wireless network base station 54, the universal repeater 56 and the remote device 58 may be divided into three stages. Details of the three stages are given below with reference to FIGS. 2A, 2B and 2C.

FIGS. 2A, 2B and 2C are schematic diagram of relationships of the three stages in a setting process of a wireless network communication system according to an embodiment of the present invention. FIG. 2A represents the first stage, and corresponds to arrow directions (i) in FIG. 1. The first stage in FIG. 2A may be described as a preparatory procedure between the wireless network base station 54 and the remote device 58 in the wireless network communication system. In the preparatory procedure, a user may place the remote device 58 at a distance closer to the wireless network base station 54, such that the remote device 58 is capable of establishing a signal connection to the wireless network base station 54. After the preparatory procedure, the user may disconnect the signal connection between the remote device 58 and the wireless network base station 54, and relocates the remote device 58 out of a signal range of the wireless network base station 54.

It should be noted that, the method for establishing the signal connection between the wireless network base station 54 and the remote device 58 at this stage is not limited. For example, the wireless network base station 54 may establish the signal connection to the remote device 58 via a first data transmission line (a dedicated transmission line or a USB transmission line etc.), an Ethernet connection or a wireless network.

When the remote device 58 is signally connected to the wireless network base station 54, the wireless network base station 54 may provide a setting page for a user to configure settings via a driver of the remote device 58. Accordingly, the user may modify the setting parameter corresponding to the wireless network 55 through the setting page.

To verify that the remote device 58 is authorized, the wireless network base station 54 may verify that the remote device 58 has access permission to the wireless network 55 through a verification program. At this point, the remote device 58 receives and stores the setting parameter corresponding to the wireless network 55 transmitted from the wireless network base station 54. For example, the setting parameter may include an identifier of basic service set, an identifier of network service set and an encryption key of network service.

FIG. 2B represents the second stage, and corresponds to arrow directions (ii) in FIG. 1. This stage in the diagram may be described as the transmission procedure of network setting between the universal repeater 56 and the remote device 58 in the wireless network communication system. At this point, the remote device 58 transmits the setting parameter corresponding to the wireless network 55 to the universal repeater 56.

In this stage, the universal repeater 56 may signally connect to the remote device 58 via a second data transmission line (e.g. a dedicated transmission line or a USB transmission line), an Ethernet connection or a wireless transmission mode, and the signal connection between the wireless network base station 54 and the remote device 58 may be disconnected. For example, the wireless transmission mode may be a wireless network transmission mode, an infrared transmission mode or a Bluetooth transmission mode.

As previously stated, the remote device 58 includes the trigger module 583. The trigger module 583 may be a hardware component or a software setting. When the user wishes to start the transmission procedure of network setting between the remote device 58 and the universal repeater 56, the user may control the trigger module 583 to generate the trigger signal.

For example, assuming that the trigger module 583 is controlled by a button disposed on a housing of the remote device 58, the user may press the button when the user wishes to transmit the setting parameter. Accordingly, the trigger module 583 generates the trigger signal that is transmitted to the transceiver module 581.

As another example, assuming that the trigger module 583 is a software setting, a setting page may be displayed via the remote device 58. When the user wishes to transmit the setting parameter, the user may select a “transmit” option in the setting page. Accordingly, an internal controller of the remote device 58 transmits the trigger signal generated to the transceiver module 581.

When the universal repeater 56 is connected to the remote device 58 by an Ethernet connection, the setting parameter corresponding to the wireless network 55 may be transmitted via the layer 2 in the network protocol.

Further, the setting parameter transmitted from the remote device 58 to the universal repeater 56 may be applied with an encryption algorithm or a checksum algorithm. The encryption algorithm may ensure the transmission security of the setting parameter, and the checksum algorithm may prevent an erroneous transmission or an error in the transmission of the setting parameter.

The transmission procedure of network setting may be a procedure that is activated between the remote device 58 and the universal repeater 56 according to a user requirement. Therefore, the trigger module may be disposed at either the remote device 58 or the universal repeater 56, or at both of the remote device 58 and the universal repeater 56. Regardless of the location and configuration of the remote device 58 and the universal repeater 56, the transmission procedure of network setting may be set by a hardware component and/or a software setting.

Assuming that the trigger module 583 is disposed only at the remote device 58, the user needs to control a hardware component or a software setting of the remote device 58 to generate the trigger signal. At this point, in a predetermined period after the universal repeater 56 connects to the remote device 58 and after the universal repeater 56 is booted on, the universal repeater 56 may be in a polling mode. The universal repeater 56 may first confirm whether it receives an instruction, which is from the remote device 58 and is for activating the transmission procedure of network setting, and then receive the setting parameter from the remote device 58.

On the other hand, assuming that the trigger module is disposed only at the universal repeater 56, the remote device 58 may be set to be in a polling mode in a predetermined period after the remote device 58 is powered on.

Further, assuming that the trigger module is disposed at both of the remote device 58 and the universal repeater 56, the trigger modules at the two ends need to connect to each other within a predetermined period to generate the trigger signal. For example, only when the remote device 58 and the universal repeater 56 have mutually confirmed to start the transmission procedure of network setting, the setting parameter corresponding to the wireless network 55 is transmitted from the remote device 58.

FIG. 2C represents the third stage, and corresponds to arrow directions (iii) in FIG. 1. The third stage in FIG. 2C may be described as a normal operation procedure performed among the wireless network base station 54, the universal repeater 56 and the remote device 58 after the wireless network setting is completed for the wireless network communication system.

The universal repeater 56 is signally connected to the wireless network 55 provided by the wireless network base station 54 according to the setting parameter corresponding to the wireless network 55. The universal repeater 56 provides extended wireless signals to the remote device 58 based on the wireless network 55.

The wireless network communication system may coordinate with the same wireless network base station 54 to be applied to more than one universal repeater 56 and remote device 58. Several exemplary applications are described below.

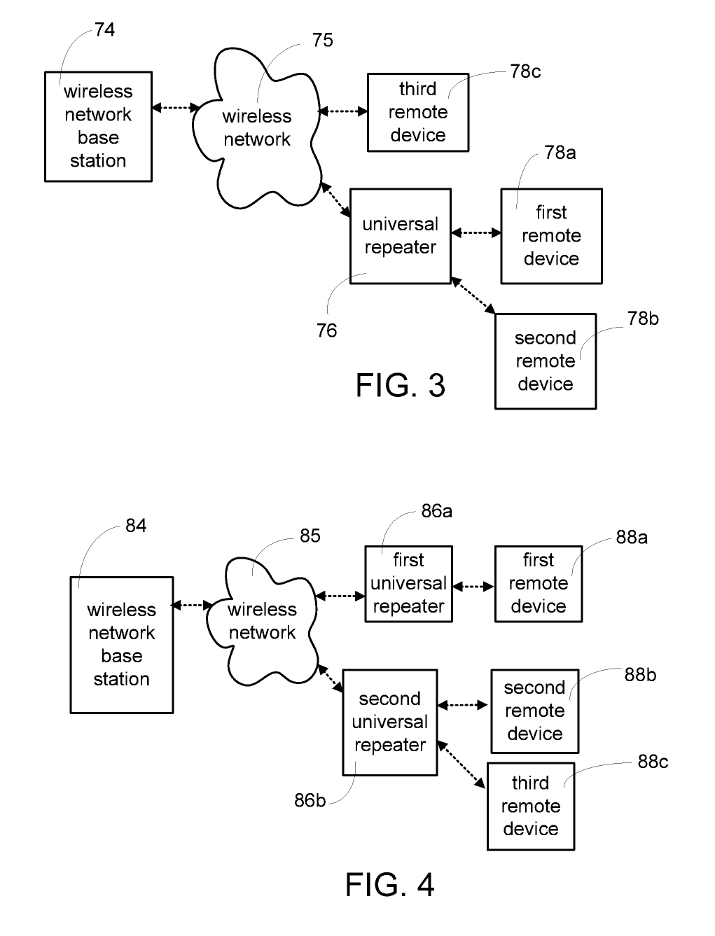

FIG. 3 shows a schematic diagram of applying a wireless network setting method to a wireless network communication system. In FIG. 3, a wireless network base station 74 signally connects to a third remote device 78c and a universal repeater 76 via a wireless network 75. The universal repeater 76 also provides an extended wireless network function to a first remote device 78a and a second remote device 78b.

Before the universal repeater 76 signally connects to the wireless network 75, the first remote device 78a is in advance signally connected to the wireless network base station 74. When signally connected to the wireless network base station 74, the first remote device 78a receives a setting parameter corresponding to the wireless network 75.

The first remote device 78a may then be relocated to a position farther away from the wireless network base station 74. At this point, the signal connection between the first remote device 78a and the wireless network base station 74 may be disconnected. The universal repeater 76 is then signally connects to the first remote device 78a via wired transmission or wireless transmission. Thus, the first remote device 78a provides the setting parameter corresponding to the wireless network base station 74 to the universal repeater 76.

After the universal repeater 76 receives the setting parameter corresponding to the wireless network base station 74 from the first remote device 78a, the wired transmission or the wireless transmission for transmitting the setting parameter between the universal repeater 76 and the first remote device 78a may be disconnected. According to the setting parameter, the universal repeater 76 signally connects to the wireless network base station 74 via the wireless network 75.

Next, the universal repeater 76 provides extended wireless signals to the first remote device 78a. Further, the second remote device 78b may also share the extended wireless network signals provided by the universal repeater 76 with the first remote device 78a.

FIG. 4 shows a schematic diagram of applying a wireless network setting method to another wireless network communication system. In FIG. 4, operation details of a wireless network base station 84, a wireless network 85, a first universal repeater 86a and a first remote device 88a are the same as those in FIG. 3, and shall be omitted herein. The wireless network communication system in FIG. 4 further illustrates that the wireless network base station 84 may be applied to multiple universal repeaters. Similarly, a second remote device 88b receives a setting parameter corresponding to the wireless network 85 from the wireless network base station 84, and provides the setting parameter to the second universal repeater 86b. According to the setting parameter, the second universal repeater 86b signally connects to the wireless network 85, and then provides extended wireless network signals to the second remote device 88b and a third remote device 88c.

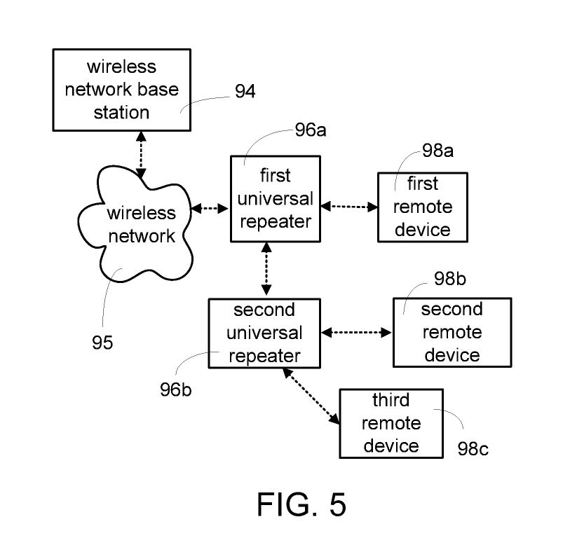

FIG. 5 shows a schematic diagram of applying a wireless network setting method to another wireless network communication system. In FIG. 5, operation details of a wireless network base station 94, a wireless network 95, a first universal repeater 96a and a first remote device 98a are the same as those in FIG. 3, and shall be omitted herein. FIG. 5 further illustrates that the wireless network communication system may further include universal repeaters that are connected in series to one another. In FIG. 5, a first universal repeater 96a and a second universal repeater 96b are given as an example. The two universal repeaters are utilized to extend wireless network signals by two stages. The first universal repeater 96a substantially provides first-stage extended wireless network signals. The second universal repeater 96b performs a second-stage signal extension by the first-stage extended wireless network signals provided by the first universal repeater 96a. Thus, the second universal repeater 96b provides the second-stage extended wireless network signals to be shared by a second remote device 98b and a third remote device 98c.

Before the second universal repeater 96b utilizes the extended wireless network signals provided by the first universal repeater 96a, the second universal repeater 96b may select either the first universal repeater 96a or the wireless network base station 94 for receiving the setting parameter corresponding to the wireless network 95.

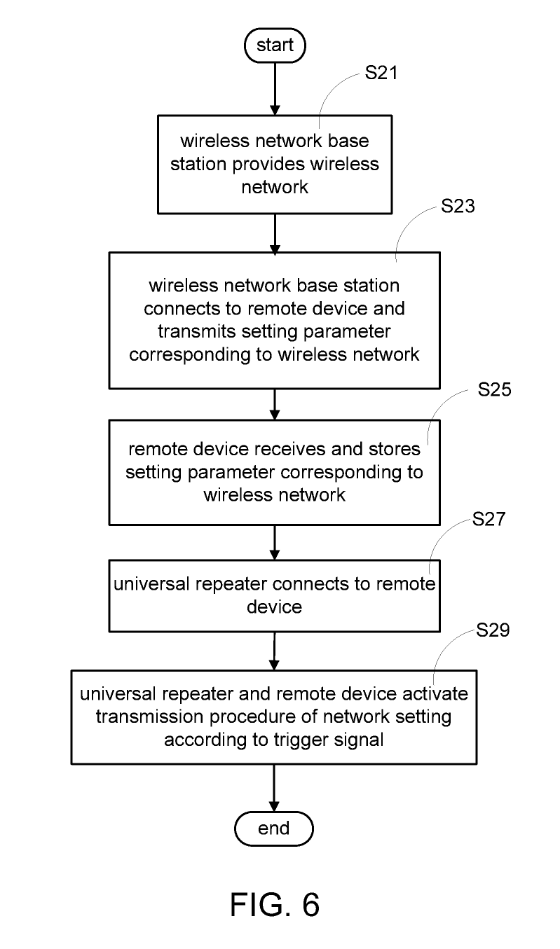

FIG. 6 shows a flowchart of a wireless network setting method according to an embodiment of the present invention. This exemplary wireless network setting method contains the following steps.

In step S21, a network base station provides a wireless network. In step S23, the network base station establishes a signal connection to a remote device and transmits a setting parameter corresponding to the wireless network. In step S25, the remote device receives and stores the setting parameter corresponding to the wireless network. In step S27, a universal repeater establishes a signal connection to the remote device. In step S29, the universal repeater activates a transmission procedure of network setting to the remote device according to a trigger signal. In the transmission procedure, the remote device transmits the setting parameter corresponding to the wireless network to the universal repeater.

Because the remote device may automatically transmit the pre-stored setting parameter to the universal repeater in response to the trigger signal, a setting procedure for the wireless network communication system is significantly simplified. The simple operations can be readily applied to various kinds of remote devices such as computers, cameras and monitors. Meanwhile, the utilization of wireless networks can also be promoted.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless network setting method, applied to a wireless network base station, a remote device and a universal repeater, the setting method comprising steps of:
the wireless network base station providing a wireless network;
the wireless network base station establishing a signal connection to the remote device and transmitting a setting parameter corresponding to the wireless network;
the remote device receiving and storing the setting parameter corresponding to the wireless network;
the universal repeater establishing a signal connection to the remote device; and
the universal repeater and the remote device activating a transmission procedure of network setting according to a trigger signal;
wherein, in the transmission procedure of network setting, the setting parameter corresponding to the wireless network is transmitted to the universal repeater.

2. The setting method according to claim 1, further comprising a step of:
disconnecting the signal connection between the wireless network base station and the remote device when the universal repeater is signally connected to the remote device.

3. The setting method according to claim 1, further comprising steps of:
the universal repeater receiving and storing the setting parameter corresponding to the wireless network;
the universal repeater signally connecting to the wireless network according to the setting parameter corresponding to the wireless network; and
the universal repeater providing an extended wireless network signal to the remote device based on the wireless network.

4. The setting method according to claim 1, wherein the step of the wireless network base station establishing the signal connection to the remote device and transmitting the setting parameter corresponding to the wireless network comprises steps of:
the wireless network base station establishing the signal connection to the remote device via a first data transmission line, an Ethernet network or the wireless network;
the wireless network base station confirming that the remote device has access permission to the wireless network through a verification program; and
the remote device receiving the setting parameter corresponding to the wireless network.

5. The setting method according to claim 4, wherein the step of the wireless network base station establishing the signal connection to the remote device and transmitting the setting parameter corresponding to the wireless network further comprises a step of:
the wireless network base station providing a setting page for modifying the setting parameter corresponding to the wireless network.

6. The setting method according to claim 5, wherein the setting parameter corresponding to the wireless network comprises an identifier of basic service set, an identifier of network service set and an encryption key of network service.

7. The setting method according to claim 1, wherein the trigger signal is generated by a hardware component or a software setting of the universal repeater or the remote device according to a network setting requirement.

8. The setting method according to claim 7, wherein when the trigger signal is generated by the hardware component, the trigger signal is generated by the hardware component in response to a user press.

9. The setting method according to claim 1, wherein the universal repeater is signally connected to the remote device via a second data transmission line, an Ethernet connection or a wireless transmission mode.

10. The setting method according to claim 9, wherein the wireless transmission mode is a wireless network transmission mode, an infrared transmission mode or a Bluetooth transmission mode.

11. The setting method according to claim 9, wherein when the universal repeater is signally connected with the remote device via the Ethernet connection, the setting parameter corresponding to the wireless network is transmitted via a layer 2 in a network protocol.

12. A wireless network communication system, comprising:
a wireless network base station, for providing a wireless network;
a remote device, signally connected to the wireless network base station, for receiving and storing a setting parameter corresponding to the wireless network, wherein the setting parameter is transmitted from the wireless network base station; and
a universal repeater, signally connected to the remote device,
wherein the universal repeater and the remote device activate a transmission procedure of network setting according to a trigger signal, and the remote device transmits the setting parameter corresponding to the wireless network to the universal repeater in the transmission procedure of network setting.

13. The communication system according to claim 12, wherein the universal repeater stores the setting parameter corresponding to the wireless network, signally connects to the wireless network according to the setting parameter corresponding to the wireless network, and provides an extended wireless network signal to the remote device based on the wireless network.

14. The communication system according to claim 12, wherein the wireless network base station establishes signal connection to the remote device via a first data transmission line, an Ethernet connection or the wireless network.

15. The communication system according to claim 12, wherein the trigger signal is generated by a trigger module of the universal repeater or of the remote device according to a network setting requirement.

16. The communication system according to claim 15, wherein the trigger module is a hardware component or a software setting.

17. The communication system according to claim 16, wherein when the trigger signal is generated by the hardware component, the trigger signal is generated by the hardware component in response to a user press.

18. The communication system according to claim 12, wherein the remote device comprises:
a transceiver module, signally connected to the wireless network base station, for receiving the setting parameter corresponding to the wireless network;
a storage module, electrically connected to the transceiver module, for storing the setting parameter corresponding to the wireless network; and
a trigger module, electrically connected to the transceiver module, for generating a trigger signal and accordingly activating a transmission procedure of network setting;
wherein, the transceiver module signally connects to the universal repeater in the transmission procedure of network setting and transmits the setting parameter corresponding to the wireless network to the universal repeater.

19. The communication system according to claim 18, wherein the transceiver module is signally connected to the universal repeater via a second data transmission line, an Ethernet connection or a wireless transmission mode.

20. A remote device, signally connected to a wireless network base station providing a wireless network, comprising:
a transceiver module, signally connected to the wireless network base station, for receiving a setting parameter corresponding to the wireless network;
a storage module, electrically connected to the transceiver module, for storing the setting parameter corresponding to the wireless network; and
a trigger module, electrically connected to the transceiver module, for generating a trigger signal and accordingly activating a transmission procedure of network setting;
wherein, the transceiver module is signally connected to a universal repeater in the transmission procedure of network setting and transmits the setting parameter corresponding to the wireless network to the universal repeater.
